(19) United States
(12) Patent Application Publication
(10) Pub. No.: US 2025/0110312 A1
(43) Pub. Date: Apr. 3, 2025

(54) OPTICAL ELEMENT DRIVING MECHANISM

(71) Applicant: TDK TAIWAN CORP., Taoyuan City (TW)

(72) Inventor: Yi-Ho CHEN, Taoyuan City (TW)

(21) Appl. No.: 18/898,072

(22) Filed: Sep. 26, 2024

Related U.S. Application Data
(60) Provisional application No. 63/586,074, filed on Sep. 28, 2023.

(51) Int. Cl. G02B 7/10

(52) U.S. Cl. CPC G02B 7/10

(57) ABSTRACT

An optical element driving mechanism is provided. The optical element driving mechanism includes a first movable part, a fixed part, and a driving assembly. The first movable part is for connecting an optical element. The first movable part may move relative to the fixed part. The driving assembly drives the first movable part to move.

### CROSS REFERENCE TO RELATED APPLICATIONS

This application claims the benefit of U.S. Provisional Application No. 63/586,074, filed 2023 Sep. 28, the entirety of which is incorporated by reference herein.

### BACKGROUND OF THE INVENTION

### Field of the Invention

The present invention relates to an optical element driving mechanism, and, in particular, to an optical element driving mechanism with a plurality of movable parts and guiding elements.

### Description of the Related Art

With the development of technology, many electronic devices today (such as laptops, smartphones, and digital cameras) are equipped with photography or video recording functions. The use of these electronic devices is becoming increasingly common, and efforts are being made to develop more stable and higher optical quality, while focusing on convenience and slim designs to provide users with more options.

In this context, there is a need for an optical element driving mechanism that allows for the adjustment of optical focal lengths to accommodate different external photography requirements. At the same time, such an optical element driving mechanism may reduce operational errors caused by interference with magnetic elements during operation, stabilize the internal structure, and provide more stable and higher optical quality.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a first movable part, a fixed part, and a driving assembly. The first movable part is for connecting an optical element. The first movable part may move relative to the fixed part. The driving assembly drives the first movable part to move.

According to certain aspects of the present disclosure, the optical element driving mechanism further includes a second movable part. The second movable part is movable relative to the fixed part in a first dimension. When the second movable part moves, the second movable part drives the first movable part to move. The first movable part is movable relative to the second movable part.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a perspective view of the optical element driving mechanism and an optical element, according to certain aspects of the present disclosure.

FIG. 2 is an exploded perspective view of the optical element driving mechanism and the optical element, according to certain aspects of the present disclosure.

FIG. 3 is a perspective view of the optical element driving mechanism, according to certain aspects of the present disclosure, with the fixed part removed for illustrative purposes, and the first movable part shown in dashed lines.

FIG. 4 is a perspective view of the optical element driving mechanism, according to certain aspects of the present disclosure, with the fixed part removed for illustrative purposes, and the first movable part, the second movable part, and the fourth movable part shown in dashed lines.

### DETAILED DESCRIPTION OF THE INVENTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features may be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended Patent Application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The present disclosure relates to an optical element driving mechanism, which has a driving assembly, and the optical element driving mechanism comprises a plurality of movable parts and guiding elements. These elements allow flexible movement of the movable parts and optical elements in various directions, thereby adjusting the imaging of the optical element driving mechanism to meet different photography needs.

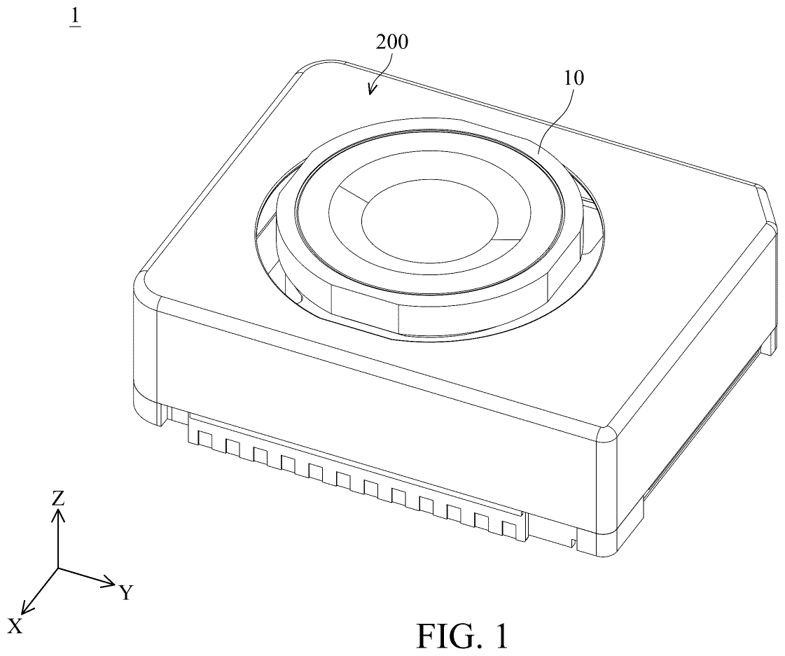

First, please refer to FIG. 1. FIG. 1 is a front perspective view of the optical element driving mechanism 1 and an optical element 10, according to certain aspects of the present disclosure.

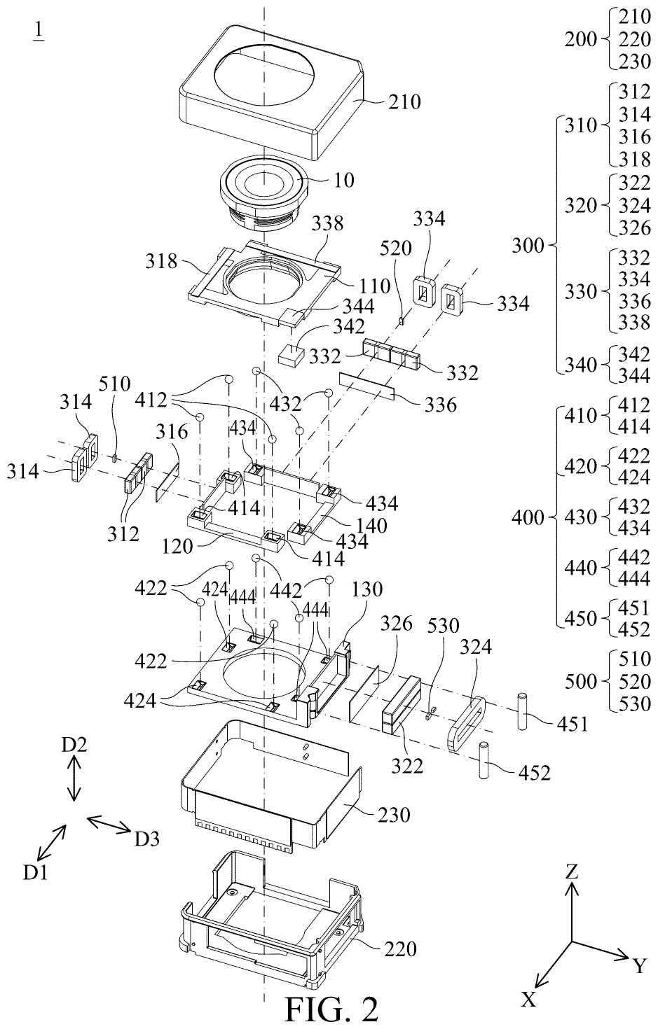

Refer to FIG. 2. FIG. 2 is an exploded perspective view of the optical element driving mechanism 1 and the optical element 10, according to certain aspects of the present disclosure. The optical element driving mechanism 1 includes a first movable part 110, a second movable part 120, a third movable part 130, a fourth movable part 140, a fixed part 200, a driving assembly 300, a guiding assembly 400, and a sensing assembly 500. The first movable part 110 is connected to the optical element 10, which may be, for example, an optical lens. The first movable part 110 may move relative to the fixed part 200. The driving assembly 300 drives the movement of the first movable part 110. The sensing assembly 500 is for sensing the movement of the optical element 10.

The first movable part 110 is movably connected to the second movable part 120 and the fourth movable part 140 via the guiding assembly 400. The first movable part 110 may move relative to the second movable part 120, the third movable part 130, the fourth movable part 140, and the fixed part 200.

The second movable part 120 is movably connected to the third movable part 130 via the guiding assembly 400. The second movable part 120 may move relative to the fixed part 200, the third movable part 130, and the fourth movable part 140 in a first dimension D1. The movement of the second movable part 120 may drive the movement of the first movable part 110.

The third movable part 130 is movably connected to the fixed part 200 via the guiding assembly 400. The third movable part 130 may move relative to the second movable part 120 and the fixed part 200. The third movable part 130 may move relative to the fixed part 200 in a second dimension D2. The movement of the third movable part 130 may drive the movements of the first movable part 110, the second movable part 120, and the fourth movable part 140. When the third movable part 130 moves, the second movable part 120 does not drive the fourth movable part 140 to move.

The fourth movable part 140 is movably connected to the third movable part 130 via the guiding assembly 400. The fourth movable part 140 may move relative to the first movable part 110, the second movable part 120, the third movable part 130, and the fixed part 200 in a third dimension D3. The movement of the fourth movable part 140 may drive the movement of the first movable part 110. When the fourth movable part 140 moves, the fourth movable part 140 does not drive the second movable part 120 to move.

The fixed part 200 includes an outer case 210, a base 220, and a circuit assembly 230. The outer case 210 and the base 220 are fixedly connected. The circuit assembly 230 is fixedly attached to the base 220. The space formed between the outer case 210 and the base 220 houses other components of the optical element driving mechanism 1 and the optical element 10.

The driving assembly 300 includes a first driving unit 310, a second driving unit 320, a third driving unit 330, and a stabilizing element 340.

The first driving unit 310 may include, for example, magnets and coils, piezoelectric elements, stepper motors, or shape memory alloys. In this embodiment, the first driving unit 310 includes two first magnetic elements 312, two first coils 314, and two magnetic guiding plates 316 and 318. The first magnetic element 312 is at least partially fixed to the second movable part 120. The first coil 314 corresponds to the first magnetic element 312. The first coil 314 is fixedly disposed on the circuit assembly 230 of the fixed part 200. One magnetic guiding plate 316 is disposed between the first magnetic element 312 and the second movable part 120, while the other magnetic guiding plate 318 is disposed above the first magnetic element 312 to prevent magnetic field interference.

By the electromagnetic driving force generated between the first magnetic element 312 and the first coil 314, the first magnetic element 312 moves relative to the first coil 314. As a result, the second movable part 120 moves relative to the circuit assembly 230, driving the movement of the first movable part 110 and the optical element 10. Thus, the electromagnetic driving force generated between the first magnetic element 312 and the first coil 314 may drive the second movable part 120 to move the first movable part 110 and the optical element 10 relative to the fixed part 200.

The second driving unit 320 may include, for example, magnets and coils, piezoelectric elements, stepper motors, or shape memory alloys. In this embodiment, the second driving unit 320 includes a second magnetic element 322, a second coil 324, and a magnetic guiding plate 326. The second magnetic element 322 is at least partially fixedly disposed on the third movable part 130. The second coil 324 corresponds to the second magnetic element 322. The second coil 324 is fixedly disposed on the circuit assembly 230 of the fixed part 200. The magnetic guiding plate 326 is disposed between the second magnetic element 322 and the third movable part 130.

By the electromagnetic driving force generated between the second magnetic element 322 and the second coil 324, the second magnetic element 322 moves relative to the second coil 324. As a result, the third movable part 130 moves relative to the circuit assembly 230, driving the movement of the first movable part 110, the second movable part 120, and the optical element 10. Thus, the electromagnetic driving force generated between the second magnetic element 322 and the second coil 324 may drive the third movable part 130 to move the first movable part 110, the second movable part 120, and the optical element 10 relative to the fixed part 200. Therefore, the third movable part 130 and the second movable part 120 is movable relative to the second coil 324.

The third driving unit 330 may include, for example, magnets and coils, piezoelectric elements, stepper motors, or shape memory alloys. In this embodiment, the third driving unit 330 includes two third magnetic elements 332, two third coils 334, and two magnetic guiding plates 336 and 338. The third magnetic element 332 is at least partially fixedly disposed to the fourth movable part 140. The third coil 334 corresponds to the third magnetic element 332. The third coil 334 is fixedly disposed on the circuit assembly 230 of the fixed part 200. One magnetic guiding plate 336 is disposed between the third magnetic element 332 and the fourth movable part 140, while the other magnetic guiding plate 338 is disposed above the third magnetic element 332 to prevent magnetic field interference.

By the electromagnetic driving force generated between the third magnetic element 332 and the third coil 334, the third magnetic element 332 moves relative to the third coil 334. As a result, the fourth movable part 140 moves relative to the circuit assembly 230, driving the movement of the first movable part 110 and the optical element 10. Thus, the electromagnetic driving force generated between the third magnetic element 332 and the third coil 334 may drive the fourth movable part 140 to move the first movable part 110 and the optical element 10 relative to the fixed part 200. Therefore, the third magnetic element 332 is movable relative to the first magnetic element 312 and the first coil 314.

The multiple driving sets of the first coil 314, the second coil 324, the third coil 334, and the first magnetic element 312, the second magnetic element 322, and the third magnetic element 332 in the driving assembly 300 allow for adjustments to be made to the optical focal length of the optical element 10 to meet various external photography needs. As well as providing sufficient driving force to support the weight of the first movable part 110, the second movable part 120, the third movable part 130, the fourth movable part 140, and the optical element 10.

The stabilizing element 340 includes a magnetic element 342 and a magnetic guiding plate 344. The magnetic element 342 is disposed on the third movable part 130. The magnetic guiding plate 344 is disposed on the first movable part 110. The attractive force between the magnetic element 342 and the magnetic guiding plate 344 provides an opposing force to the first magnetic element 312 and the second magnetic element 322. The opposing force ensures that the internal structure of the optical element driving mechanism 1 does not tip over due to excessive magnetic forces from the first magnetic element 312 and the second magnetic element 322.

The stabilizing element 340 stabilizes the internal structure of the optical element driving mechanism 1 and reduces operational errors in the driving assembly 300 during operation.

The guiding assembly 400 corresponds to the second movable part 120, the fourth movable part 140, and the third movable part 130. The guiding assembly 400 flexibly connects the first movable part 110, the second movable part 120, the third movable part 130, and the fourth movable part 140. The guiding assembly 400 includes a first guiding part 410, a second guiding part 420, a third guiding part 430, a fourth guiding part 440, and a fifth guiding part 450. The first guiding part 410, the second guiding part 420, the third guiding part 430, and the fourth guiding part 440 all have flexibility. Each of the guiding parts corresponds to the connections between the first movable part 110 and the second movable part 120, the second movable part 120 and the third movable part 130, the first movable part 110 and the fourth movable part 140, and the third movable part 130 and the fourth movable part 140.

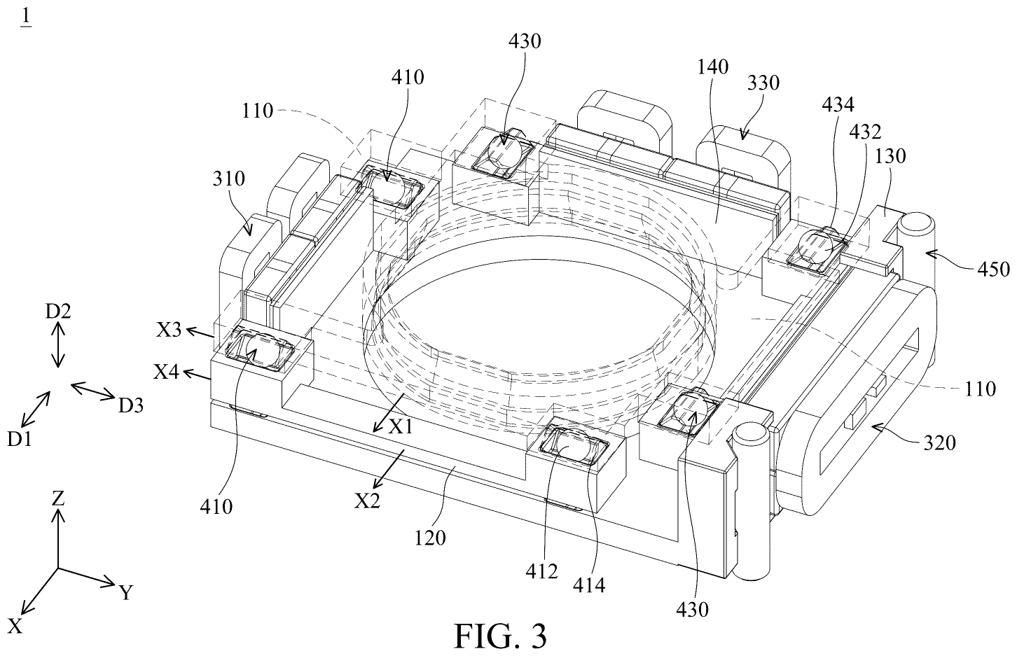

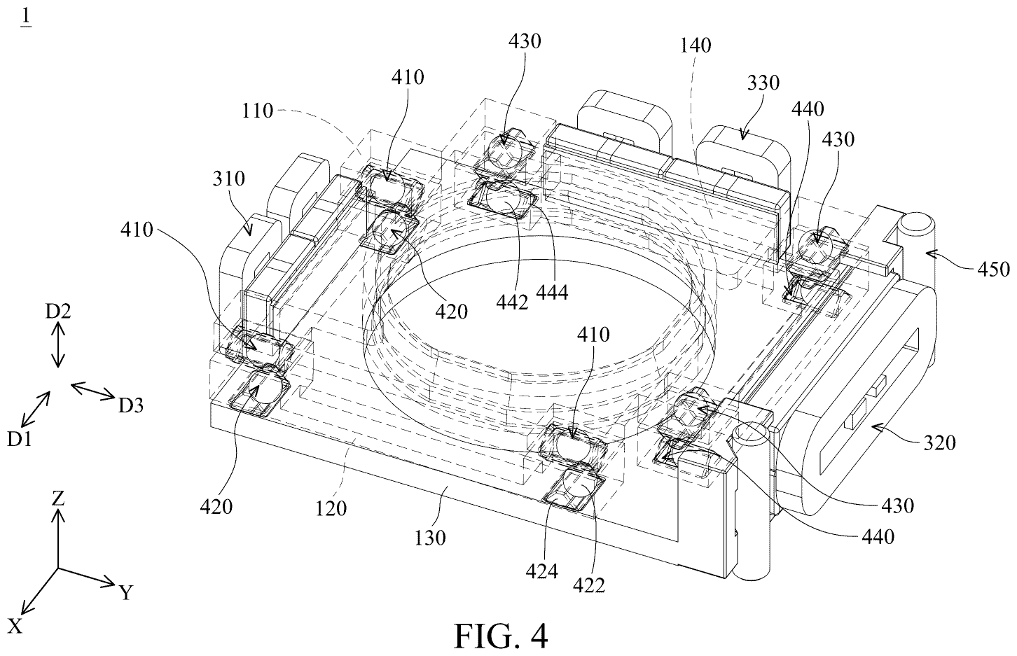

Next, please also refer to FIG. 2 to FIG. 4. FIG. 3 is a perspective view of the optical element driving mechanism 1, according to certain aspects of the present disclosure, with the fixed part 200 removed for illustrative purposes, and the first movable part 110 shown in dashed lines. FIG. 4 is a perspective view of the optical element driving mechanism 10, according to certain aspects of the present disclosure, with the fixed part 200 removed for illustrative purposes, and the first movable part 110, the second movable part 120, and the fourth movable part 140 shown in dashed lines.

The first guiding part 410 is movably connected to the second movable part 120 and the first movable part 110. The second movable part 120 drives the movement of the first movable part 110 via the first guiding part 410.

The second guiding part 420 is movably connected to the second movable part 120 and the third movable part 130. The second movable part 120 moves in the first dimension D1 via the second guiding part 420.

The third guiding part 430 is movably connected to the fourth movable part 140 and the first movable part 110. The fourth movable part 140 drives the movement of the first movable part 110 via the third guiding part 430.

The fourth guiding part 440 is movably connected to the fourth movable part 140 and the third movable part 130. The fourth movable part 140 moves in the third dimension D3 via the fourth guiding part 440.

The fifth guiding part 450 is movably connected to the third movable part 130 and the base 220 of the fixed part 200. The third movable part 130 moves in the second dimension D2 via the fifth guiding part 450.

In this embodiment, the guiding assembly 400 is in the form of spheres and grooves. The first guiding part 410 includes three spheres 412 and three ball grooves 414. The ball grooves 414 have an elongated structure extending in the third dimension D3, allowing the spheres 412 to move in the third dimension D3 when positioned within the ball grooves 414. Since the spheres 412 have minimal movement space in the first dimension D1, when the second movable part 120 moves in the first dimension D1, the first movable part 110 is driven to move by the first guiding part 410. Conversely, because the spheres 412 may move in the third dimension D3, when the first movable part 110 moves in the third dimension D3, the second movable part 120 is not driven by the first movable part 110 to move.

The second guiding part 420 includes three spheres 422 and three ball grooves 424. The ball grooves 424 have an elongated structure extending in the first dimension D1, allowing the spheres 422 to move in the first dimension D1 when positioned within the grooves 424. Therefore, when the second movable part 120 is driven by the first driving unit 310, the second movable part 120 may move in the first dimension D1 relative to the third movable part 130.

The third guiding part 430 includes three spheres 432 and three ball grooves 434. The ball grooves 434 have an elongated structure extending in the first dimension D1, allowing the spheres 432 to move in the first dimension D1 when positioned within the grooves 434. Since the spheres 432 have minimal movement space in the third dimension D3, when the fourth movable part 140 moves in the third dimension D3, the first movable part 110 is driven to move by the third guiding part 430. Conversely, since the spheres 432 may move in the first dimension D1, when the first movable part 110 moves in the first dimension D1, the fourth movable part 140 is not driven by the first movable part 110 to move.

The fourth guiding part 440 includes three spheres 442 and three ball grooves 444. The ball grooves 444 have an elongated structure extending in the third dimension D3, allowing the spheres 442 to move in the third dimension D3 when positioned within the grooves 444. Therefore, when the fourth movable part 140 is driven by the third driving unit 330, the fourth movable part 140 may move in the third dimension D3 relative to the third movable part 130.

The fifth guiding part 450 includes two guiding rods 451 and 452. When the third movable part 130 is driven by the second driving unit 320, the third movable part 130 may move in the second dimension D2 relative to the base 220 of the fixed part 200 via the two guiding rods 451 and 452.

When the second movable part 120 moves in the first dimension D1, the second movable part 120 drives the movement of the first movable part 110. When the first movable part 110 moves a first movement value X1, the second movable part 120 moves a second movement value X2. Generally, the second movement value X2 is greater than or equal to the first movement value X1. For example, when the second movement value X2 is 10 micrometers, the first movement value X1 may be 10 micrometers or less than 10 micrometers.

When the first movable part 110 moves in the third dimension D3, the first movable part 110 generally does not drive the second movable part 120 to move. That is, when the first movable part 110 moves a third movement value X3 in the third dimension D3, the second movable part 120 moves a fourth movement value X4, in this case, the value of the fourth movement value X4 is generally 0.

The ratio of the fourth movement value X4 to the third movement value X3 is less than the ratio of the second movement value X2 to the first movement value X1. For example, the ratio of the second movement value X2 to the first movement value X1 is 1, while the ratio of the fourth movement value X4 to the third movement value X3 is 0.

Next, please continue to refer to FIG. 2. The sensing element 500 includes a first sensing element 510, a second sensing element 520, and a third sensing element 530. The first sensing element 510, the second sensing element 520, and the third sensing element 530 are all disposed on the circuit assembly 230. The first sensing element 510 is disposed in the first coil 314 to sense the movement of the second movable part 120. The second sensing element 520 is disposed in the third coil 334 to sense the movement of the fourth movable part 140. The third sensing element 530 is disposed in the second coil 324 to sense the movement of the third movable part 130.

In another embodiment, the guiding assembly 400 may come in the form of springs (not shown). In this configuration, the first guiding part 410, the second guiding part 420, the third guiding part 430, and the fourth guiding part 440 are separate springs that individually connect the first movable part 110, the second movable part 120, the third movable part 130, and the fourth movable part 140.

The first guiding part 410 is a spring connecting the first movable part 110 to the second movable part 120. The second guiding part 420 is a spring connecting the second movable part 120 to the third movable part 130. The third guiding part 430 is a spring connecting the first movable part 110 to the fourth movable part 140. The fourth guiding part 440 is a spring connecting the third movable part 130 to the fourth movable part 140.

The first guiding part 410 is flexible and has a first elasticity coefficient K1 corresponding to the first dimension D1, and a second elasticity coefficient K2 corresponding to the third dimension D3. The first elasticity coefficient K1 is different from the second elasticity coefficient K2.

The second guiding part 420 has a third elasticity coefficient K3 corresponding to the first dimension D1, and a fourth elasticity coefficient K4 corresponding to the third dimension D3.

The third elasticity coefficient K3 is less than the fourth elasticity coefficient K4. The first elasticity coefficient K1 is greater than the second elasticity coefficient K2.

In the embodiment where the guiding assembly 400 is flexible, when the first movable part 110 moves in the third dimension D3, the first movable part 110 may drive the movement of the second movable part 120. When the first movable part 110 moves a third movement value X3, due to the flexibility of the first guiding part 410, the second movable part 120 is driven by the first movable part 110 to move a fourth movement value X4. Generally, the fourth movement value X4 is less than the third movement value X3. For example, when the fourth movement value X4 is 1 micrometers, the third movement value X3 may be 10 micrometer. In this embodiment, the ratio of the fourth movement value X4 to the third movement value X3 is 0.1.

In summary, the present disclosure provides an optical element driving mechanism that includes a plurality of movable parts, a fixed part, a driving assembly, a guiding assembly, and a sensing assembly. The movement of the driving assembly drives the plurality of movable parts to move relative to each other and the fixed part. This allows for the adjustment of the optical element's position to meet different photographic needs, also providing more stable optical quality. Moreover, since the sensing assembly and the first coil, the second coil, the third coil, and the fourth coil of the driving assembly may be disposed on the circuit assembly of the fixed part, the present invention does not need for designing complex circuit routing and corresponding structures on the movable part to be electrically connected to the fixed part, thus achieving the effect of reducing costs, simplifying the overall structure, and simplifying circuit design.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments may be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, comprising:
a first movable part, for connecting an optical element;
a fixed part, wherein the first movable part is movable relative to the fixed part; and
a driving assembly, driving the first movable part to move.

2. The optical element driving mechanism as claimed in claim 1, further comprising a second movable part that is movable relative to the fixed part in a first dimension, wherein when the second movable part moves, the second movable part drives the first movable part to move.

3. The optical element driving mechanism as claimed in claim 2, wherein the first movable part is movable relative to the second movable part.

4. The optical element driving mechanism as claimed in claim 2, further comprising a third movable part that is movable relative to the fixed part in a second dimension, wherein when the third movable part moves, the third movable part drives the first movable part and the second movable part to move.

5. The optical element driving mechanism as claimed in claim 4, wherein:
the first movable part is movable relative to the third movable part; and
the third movable part is movable relative to the second movable part.

6. The optical element driving mechanism as claimed in claim 4, further comprising a fourth movable part that is movable relative to the fixed part in a third dimension, wherein when the fourth movable part moves, the fourth movable part drives the first movable part to move.

7. The optical element driving mechanism as claimed in claim 6, wherein the fourth movable part is movable relative to the first movable part and the second movable part.

8. The optical element driving mechanism as claimed in claim 6, wherein:
when the fourth movable part moves, the fourth movable part does not drive the second movable part to move; and
when the third movable part moves, the second movable part does not drive the fourth movable part to move.

9. The optical element driving mechanism as claimed in claim 6, wherein the driving assembly includes:
a first magnetic element, at least partially fixedly disposed on the second movable part;
a first coil, corresponding to the first magnetic element, wherein the second movable part is movable relative to the first coil;
a second magnetic element, at least partially fixedly disposed on the third movable part;
a second coil, corresponding to the second magnetic element, wherein the third movable part and the second movable part are movable relative to the second coil; and
a third magnetic element, at least partially fixedly disposed on the fourth movable part, wherein the third magnetic element is movable relative to the first magnetic element and the first coil.

10. The optical element driving mechanism as claimed in claim 6, wherein when the first movable part moves in the first dimension, the first movable part drives the second movable part to move, and when the first movable part moves a first movement value, the second movable part moves a second movement value.

11. The optical element driving mechanism as claimed in claim 10, wherein when the first movable part moves in the third dimension, the first movable part drives the second movable part to move, and when the first movable part moves a third movement value, the second movable part moves a fourth movement value.

12. The optical element driving mechanism as claimed in claim 11, wherein the fourth movement value is less than the third movement value.

13. The optical element driving mechanism as claimed in claim 11, wherein the ratio of the fourth movement value to the third movement value is different from the ratio of the second movement value to the first movement value.

14. The optical element driving mechanism as claimed in claim 11, wherein the ratio of the fourth movement value to the third movement value is less than the ratio of the second movement value to the first movement value.

15. The optical element driving mechanism as claimed in claim 6, further comprising a guiding assembly corresponding to the second movable part, wherein the guiding assembly includes:
a first guiding part, wherein the second movable part drives the first movable part to move via the first guiding part, and the first guiding part is flexible; and
a second guiding part, wherein the second movable part moves relative to the fixed part via the second guiding part, and the second guiding part is flexible.

16. The optical element driving mechanism as claimed in claim 15, wherein:
the first guiding part has a first elasticity coefficient corresponding to the first dimension and a second elasticity coefficient corresponding to the third dimension; and
the second guiding part has a third elasticity coefficient corresponding to the first dimension and a fourth elasticity coefficient corresponding to the third dimension.

17. The optical element driving mechanism as claimed in claim 16, wherein:
the third elasticity coefficient is different from the fourth elasticity coefficient; and
the first elasticity coefficient is different from the second elasticity coefficient.

18. The optical element driving mechanism as claimed in claim 16, wherein:
the third elasticity coefficient is less than the fourth elasticity coefficient; and
the first elasticity coefficient is greater than the second elasticity coefficient.

19. The optical element driving mechanism as claimed in claim 6, wherein when the first movable part moves in the third dimension, the first movable part does not drive the second movable part to move.

20. The optical element driving mechanism as claimed in claim 6, further comprising a guiding assembly corresponding to the second movable part, wherein the guiding assembly includes:
a first guiding part, wherein the second movable part drives the first movable part to move via the first guiding part, and the first guiding part is flexible; and
a second guiding part, wherein the second movable part moves relative to the fixed part via the second guiding part, and the second guiding part is flexible.
